(19) United States
(12) Patent Application Publication
(10) Pub. No.: US 2010/0234561 A1
(43) Pub. Date: Sep. 16, 2010

(54) PROCESS FOR PRODUCING FINE PARTICLES

(75) Inventor: Kazumichi Nakahama, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/377,972

(22) PCT Filed: Aug. 8, 2007
(86) PCT No.: PCT/JP2007/065883

§ 371 Date: Feb. 18, 2009

(30) Foreign Application Priority Data
Aug. 31, 2006 (JP) 2006-236723

(51) Int. Cl. C08J 3/14

(52) U.S. Cl. 528/502 R

(57) ABSTRACT

A process for producing fine particles is provided including the steps of (1) preparing a solution having a viscosity of 20 mPa·s or less at 25° C. by using a polymer and a first solvent, (2) mixing the solution with a second solvent to prepare an emulsion and (3) removing the first solvent from the emulsion to obtain fine particles containing the polymer.

### TECHNICAL FIELD

This invention relates to a process for producing fine particles applicable to comprehensive fields inclusive of electronic materials, optical materials, and medical materials. More particularly, it relates to a process for producing monodisperse fine particles submicron sized or smaller.

### BACKGROUND ART

In recent years, toward application to the fields of electronic materials, optical materials, and medical materials, research and development are energetically made on fine particles submicron sized or smaller.

With regard to fine particles of a polymer type, emulsion polymerization is available as a typical method for obtaining fine particles submicron sized or smaller (hereinafter often referred to simply as “fine particles”) (“Advanced Technology of Nanospheres and Microspheres”, CMC Publishing Co., Ltd., pp. 35-36, 2004).

This method is an industrially advantageous method, but is applicable to only a few types of polymers. Accordingly, it is difficult to meet the diversified needs in recent years. Taking account of polymerization mechanism, it is also difficult to produce fine particles whose interiors functional materials such as coloring materials or magnetic materials have been enclosed in (hereinafter referred to as “composite fine particles”).

Mini-emulsion polymerization is proposed as a method which can relatively easily produce fine particles submicron sized or smaller and composite fine particles (Japanese Patent Application Laid-Open No. 2004-67883).

In this method, a slightly water-soluble low-molecular substance (hereinafter referred to as “hydrophobe”) is added to stabilize a monomer emulsion having submicron sized or smaller particles, and polymerization reaction is allowed to proceed to make the monomer emulsion as such into fine particles. This method, however, as in the afore-mentioned emulsion polymerization method, is applicable to only a few types of polymers. It also has a problem that, where it is attempted to produce composite fine particles, functional materials come off from an emulsion during the course of formation of the emulsion or during the course of polymerization, resulting in low enclosure efficiency.

The above Japanese Patent Application Laid-open No. 2004-67883 proposes a self-organized precipitation method in which a polymer is dissolved in a good solvent, and a bad solvent for the polymer is added to the resultant solution, during which the good solvent is gradually evaporated to finally precipitate fine high-polymer particles in the bad solvent.

This method is applicable to extensive polymers, but it is difficult to control particle diameter and particle size uniformity. In the case where the composite fine particles are produced, this method is supposed to require further studies on processes.

### DISCLOSURE OF THE INVENTION

The present invention has been made taking account of such background art. Accordingly, an object of the present invention is to provide a process for producing fine particles having superior particle size uniformity.

The process for producing fine particles which is provided by the present invention is characterized by having the steps of:

(1) preparing a solution having a viscosity of 20 mPa·s or less at 25° C. by using a polymer and a first solvent;

(2) mixing the solution with a second solvent to prepare an emulsion; and

(3) removing the first solvent from the emulsion to obtain fine particles containing the polymer.

Further features of the present invention will become apparent from the following description of exemplary embodiments.

### BEST MODE FOR CARRYING OUT THE INVENTION

The present invention has been made on the following finding made by the present inventor. That is, the finding is such that an emulsion having submicron sized or smaller particles may be formed using i) a solution prepared by dissolving a polymer in a first solvent and ii) a second solvent immiscible with the first solvent, and then the first solvent may be removed from this emulsion by evaporation or extraction, whereby fine particles having superior particle size uniformity can be produced.

The process for producing fine particles according to the present invention is characterized by having the steps of (1) preparing a solution having a viscosity of 20 mPa·s or less at 25° C., by using a polymer and a first solvent, (2) mixing the solution with a second solvent to prepare an emulsion, and (3) removing the first solvent from the emulsion to obtain fine particles containing the polymer.

According to the present invention, a process can be provided which can easily produce fine particles whose particle diameter and particle size distribution have been controlled using a polymer in conformity with intended use. Also, with the aim of endowing fine particles with further functions, a process can be provided which can efficiently produce composite fine particles.

In the present invention, the polymer may be one which is soluble in the first solvent and is slightly soluble in the second solvent.

The first solvent and the second solvent may be immiscible with each other.

The emulsion may be one having one-peak particle size distribution.

The emulsion may have an average particle diameter in the range of 20 nm or more and 1,000 nm or less and a dispersibility index of 1.5 or less.

In the present invention, a dispersing agent may be added to at least one of the solution and the second emulsion.

The step of preparing the emulsion may include a step of mixing the solution with the second solvent to prepare a first emulsion and a step of subjecting the first emulsion to shearing treatment to prepare a second emulsion.

Using a functional material in addition to the polymer and the first solvent, the solution is prepared so as to produce composite fine particles containing the polymer and the functional material.

The mechanism of producing the fine particles or the composite fine particles in the present invention will be explained below.

Usually, where water is mixed with oil to make up an O/W (oil-in-water) emulsion and this emulsion is further subjected to shearing treatment to form an emulsion having submicron sized or smaller particles, a crude emulsion having non-uniform particle size distribution occurs as an intermediate state.

If such a crude emulsion has occurred, Ostwald ripening is accelerated because of a difference in particle diameter for each oil droplet, and hence it is very difficult to produce a monodisperse emulsion having submicron sized or smaller particles (hereinafter referred to as “mini-emulsion”).

A method capable of effectively controlling the Ostwald ripening to prepare such a mini-emulsion is known utilizing a slightly water-soluble low-molecular substance called a hydrophobe.

Where the hydrophobe is added to an oily phase to make up an O/L emulsion, osmotic pressure that opposes Laplace pressure is produced to reach pressure equilibrium between all oil droplets, so that the Ostwald ripening can be controlled to constantly form the mini-emulsion.

In the present invention, the polymer intended to be made into fine particles is allowed to function as a hydrophobe substitute substance (a pressure modifier) to stabilize the mini-emulsion.

The polymer is dissolved in a first solvent in an appropriate quantity to make up a solution. This solution is mixed with a second solvent substantially immiscible with the first solvent, and the mixture obtained is subjected to shearing treatment to form as an intermediate state a mini-emulsion having the solution as a dispersoid. Further, only the first solvent is selectively removed by evaporation or extraction, thus the intended fine high-polymer particles can be produced.

Further, the process of the present invention may be applied to produce composite fine particles in the following way.

The polymer in an appropriate quantity and an intended functional material are mixed with a first solvent to make up a liquid mixture. This liquid mixture is mixed with a second solvent substantially immiscible with the first solvent, and the mixture obtained is subjected to shearing treatment to form as an intermediate state a mini-emulsion having the liquid mixture as a dispersoid.

Further, only the first solvent is selectively removed by evaporation or extraction, thus composite fine particles composed of the polymer and the functional material can be produced. In this case, the liquid mixture is a liquid small in diffusivity containing the polymer, and hence the functional material can effectively be kept from coming off from the dispersoid due to the shearing treatment. Thus, the present invention is a production process suitable for the production of composite fine particles.

In the monodispersibility of monodisperse fine particles at which the present invention is aimed, the fine particles have one-peak particle size distribution and have a dispersibility index of 1.5 or less, preferably 1.3 or less, and more preferably 1.2 or less.

The dispersibility index in the present invention refers to a dispersibility index calculated from a number average particle diameter (Dn) and a weight average particle diameter (Dw), Dw/Dn.

The mini-emulsion in the present invention refers to a monodisperse emulsion which has one-peak particle size distribution, an average particle diameter of 20 nm or more and 1,000 nm or less, and preferably 50 nm or more and 500 nm or less, and a dispersibility index of 1.5 or less, and preferably 1.3 or less.

The emulsion with features falling within such ranges is strongly affected by the Ostwald ripening, and hence is very difficult to stabilize without adding the hydrophobe or the pressure modifier (hydrophobe substitute) such as the polymer in the present invention.

Combination of solubilities of the respective polymer, first solvent and second solvent is very important.

More specifically, any polymers, first solvents and second solvents may be used as long as they can make a combination satisfying the condition that the polymer is soluble in the first solvent and slightly soluble in the second solvent and the first solvent is immiscible with the second solvent.

It is possible to make an evaluation on whether or not the polymer is soluble or slightly soluble in solvents according to the following method.

The polymer is beforehand so mixed as to be 3% by mass based on the solvent, and the resulting mixture is shaken at 25° C. for 24 hours, then left standing for 24 hours. When the mixture is present in a uniform state, the polymer is defined as soluble; and, when the mixture is present in an imperfect state of dissolution showing a gel-like or granular appearance or looking visibly cloudy, the polymer is defined as slightly soluble.

In the present invention, it should be noted that the expression “slightly soluble” includes an insoluble state in which the interaction between the solvent and the polymer is not recognized. Where it is difficult to judge the solubility by visual observation, the transmittance of a solution or dispersion in which the polymer is dissolved or dispersed may be measured, and the resultant value may be used as an index of solubility. In this case, in the present invention, a case in which the transmittance is 95% or more is defined as soluble, and a case in which the transmittance is less than 95% is defined as slightly soluble. The transmittance may be measured by a known method. In the present invention, the transmittance of 500 nm incident light as measured with a U-2001 model double-beam spectrophotometer (manufactured by Hitachi Ltd) is used as an evaluation standard.

In the present invention, that the first solvent is immiscible with the second solvent means that the solvents are substantially immiscible with each other, including “slightly miscible”.

In the present invention, the combination in which the first solvent is immiscible with the second solvent is applicable to any combinations as long as a good mini-emulsion can be formed. It is preferable that the solubility of the first solvent in the second solvent is 3% by mass or less at normal temperature (20° C.). The combination is also preferable in which the solubility of the second solvent in the first solvent is 3% by mass or less at normal temperature (20° C.)

The polymer in the present invention may be any polymers as long as they satisfy the combination of the solubilities in the first solvent and second solvent. For example, the polymer may include general-purpose polymers polyolefin compounds, polyamide compounds as typified by nylons, conductive polymers such as polythiophene and polyacetylene, polymers derived from living organisms, such as polyamino acids, and biodegradable polymers such as poly(fatty acid esters).

However, it should be noted that the polymer in the present invention is by no means limited to the foregoing, and any polymers may be used as long as the objective of the present invention can be achieved. The polymers may be used singly or in a combination of two or more types.

The first solvent and second solvent in the present invention may be any solvents as long as they satisfy the above combination of the solubilities of the polymer, and the solubilities between the first solvent and second solvent.

For example, the first solvent used when an O/W emulsion is formed as an intermediate state, includes the following:

Halogenated hydrocarbons such as dichloromethane, chloroform, chloroethane, dichloroethane, trichloroethane, and carbon tetrachloride; ketones as exemplified by acetone, methyl ethyl ketone, and methyl isobutyl ketone; ethers such as tetrahydrofuran, ethyl ether, and isobutyl ether; esters such as ethyl acetate and butyl acetate; and aromatic hydrocarbons such as benzene, toluene and xylene. Any of these may be used singly or in the form of a mixture of two or more types in an appropriate proportion.

As the first solvent, the halogenated hydrocarbons and aromatic hydrocarbons are particularly preferable. As examples of the second solvent, water and an aqueous liquid are preferred. However, it should be noted that the first solvent and the second solvent are by no means limited to these as long as the objective of the present invention can be achieved.

For example, as the first solvent used when an O/W emulsion is formed as an intermediate state, water or an aqueous liquid is preferred. Examples of the second solvent include the following:

Halogenated hydrocarbons such as dichloromethane, chloroform, chloroethane, dichloroethane, trichloroethane, and carbon tetrachloride; ketones as exemplified by acetone, methyl ethyl ketone, and methyl isobutyl ketone; ethers such as tetrahydrofuran, ethyl ether, and isobutyl ether; esters such as ethyl acetate and butyl acetate; and aromatic hydrocarbons such as benzene, toluene and xylene. Any of these may be used singly or in the form of a mixture of two or more types in an appropriate proportion. As the second solvent, the halogenated hydrocarbons and aromatic hydrocarbons are particularly preferable. However, it should be noted that the first solvent and the second solvent are by no means limited to these as long as the objective of the present invention can be achieved.

The solution or liquid mixture in the present invention is required to have a viscosity of 20 mPa·s or less at 25° C. If the viscosity is higher than 20 mPa·s, it is difficult to form the mini-emulsion as an intermediate state by a known method. This has been experimentally ascertained. The viscosity is more preferably 15 mPa·s or less, and still more preferably 10 mPa·s or less, where the present invention can more desirably be carried out.

The viscosity of the solution or liquid mixture in the present invention may be evaluated by a conventionally known method. The viscosity can be measured, for example, with an existent viscometer as exemplified by VISCOMETER CONTROLLER RC-100, manufactured by Toki Sangyo Co., Ltd.

The functional material in the present invention is a material other than the polymer to be made into fine particles, the first and second solvents and a dispersing agent added in order to improve dispersion stability of the emulsion. As the functional material, any materials may be used as long as they can provide fine particles with an additional function.

Examples of such a material includes medicines, coloring materials, fluorescent materials, metals and metal oxides. However, it should be noted that the examples are by no means limited to these as long as the objective of the present invention can be achieved.

The composite fine particles in the present invention include the polymer and the functional material.

The functional material to be included in the composite fine particles may preferably be in a content of 1% by mass or more and 80% by mass or less, more preferably 5% by mass or more and 70% by mass or less, and still more preferably 10% by mass or more and 60% by mass or less, where the functional material may particularly preferably be used.

If the content is less than 1% by mass, there is a possibility that the composite fine particles can not function as such. On the other hand, if the content is more than 80% by mass, it is difficult in some cases for the properties of the polymer to reflect on the properties of the composite fine particles.

In the step of preparing the emulsion in the present invention, a dispersing agent may be added to either or both of the first solvent and the second solvent.

Examples of the dispersing agent include the following:

Anionic surface-active agents as exemplified by sodium oleate, sodium stearate and sodium laurate; nonionic surface-active agents as exemplified by polyoxyethylene sorbitan fatty acid esters such as TWEEN 80 and TWEEN 60, available from Atlas Powder Company, U.S.A., and polyoxyethylene caster oil derivatives such as HCO-70, HCO-60 and HCO-50, available from Nikko Chemicals Co., Ltd.; and polyvinyl pyrrolidone, polyvinyl alcohol, carboxymethyl cellulose, lecithin, gelatin, hyaluronic acid, and derivatives of these. These may be used singly or in combination.

The concentration of the dispersing agent is not limitative as long as the present invention can be carried out, and may be in the range of 0.01% by mass or more and 20% by mass or less, and preferably 0.05% by mass or more and 10% by mass or less.

In the present invention, the mini-emulsion may be prepared through the following steps. However, preparation of the mini-emulsion in the present invention is by no means limited to the following steps. Any method may be used as long as the present invention can be carried out.

First, a solution is prepared using the polymer and the first solvent. This solution is mixed with the second solvent, and then emulsification is performed to prepare a first emulsion.

The first emulsion is a polydisperse emulsion made up of the above solution as a dispersoid and the second solvent as a dispersion medium. This first emulsion may be prepared by a conventionally known emulsification method as exemplified by intermittent shaking, stirring using a mixer such as a propeller mixer or a turbine impeller mixer, colloid milling, homogenizing or ultrasonic irradiation.

Next, the first emulsion is further subjected to an additional emulsification process for preparing a second emulsion. The second emulsion is a mini-emulsion with a superior monodispersity, which has an average particle diameter in the range of 20 nm or more and 1,000 nm or less and a dispersibility index of 1.5 or less. The objective of the present invention can not be achieved without passing through the mini-emulsion as an intermediate state. The second emulsion may be prepared by a conventionally known emulsification method. In particular, homogenizing or ultrasonic irradiation is preferred. It is effective to carry out shearing treatment by using any of these.

In the present invention, the step of preparing the first emulsion and the step of preparing the second emulsion may be carried out by one-step emulsification process. However, the desired mini-emulsion can easily be obtained where the emulsification is carried out through two-step emulsification process. The emulsification may also be carried out through two or more multi-step emulsification process as long as the present invention can effectively be carried out.

The composite fine particles containing the polymer and the functional material may be prepared in the same manner as described above in the preparation of the emulsion, except that the polymer, the functional material and the first solvent are used to prepare a liquid mixture.

To remove the first solvent from the mini-emulsion in the present invention, it may be removed by a conventionally known method. For example, the following methods are available: a method in which the mini-emulsion is stirred by means of a propeller mixer or a magnetic stirrer, during which the first solvent is removed by evaporation under normal pressure or under gradually reduced pressure; a method in which a rotary evaporator is used to remove the first solvent by evaporation under control of degree of vacuum and temperature; and a method in which a solvent soluble in both the first solvent and the second solvent is added to remove the first solvent by extraction.

The average particle diameters and dispersibility indexes of the emulsion, fine particles and composite fine particles may be evaluated by a conventionally known method.

As for a method suitable for evaluating the particle diameter of the target fine particles, it is preferable to make a measurement by a dynamic light scattering method. It is further preferable in view of measurement precision to make an evaluation by analysis according to the Marquardt method, using DLS8000 manufactured by Otsuka Electronics Co., Ltd.

### Examples

The present invention is described below in greater detail by way of working examples. The present invention is by no means limited to these working examples.

### Example 1

Production of Fine Particles 1

0.3 g of polystyrene was weighed in 6 g of chloroform to prepare a liquid chloroform solution. The solution at this stage was ascertained to have a viscosity of 20 mPa·s or less at 25° C. 0.05 g of sodium dodecyl sulfate (SDS) was dissolved in 24 g of water to prepare an aqueous SDS solution. The liquid chloroform solution and the aqueous SDS solution were mixed to make up a liquid mixture. This liquid mixture was subjected to shearing treatment for 1 hour by means of a stirring homogenizer to make up a first emulsion.

Next, the first emulsion was subjected to shearing treatment for 4 minutes by means of an ultrasonic homogenizer to prepare a second emulsion. The second emulsion was evaluated by using DLS8000 (manufactured by Otsuka Electronics Co., Ltd.) and ascertained to have particles having an average particle diameter of 204 nm and a dispersibility index of 1.2.

Next, the second emulsion was set in an evaporator under reduced pressure, thus the chloroform was removed from the second emulsion by evaporation to prepare Fine Particles 1 including the polystyrene. Fine Particles 1 were evaluated by using DLS8000 (manufactured by Otsuka Electronics Co., Ltd.) and was ascertained to have an average particle diameter of 159 nm and a dispersibility index of 1.1.

### Example 2

Production of Fine Particles 2

0.2 g of polythiophene was weighed in 6 g of chloroform to prepare a liquid chloroform solution. The solution at this stage was ascertained to have a viscosity of 20 mPa·s or less at 25° C. 0.05 g of sodium dodecyl sulfate (SDS) was dissolved in 24 g of water to prepare an aqueous SDS solution. The liquid chloroform solution and the aqueous SDS solution were mixed to make up a liquid mixture. This liquid mixture was subjected to shearing treatment for 1 hour by means of a stirring homogenizer to make up a first emulsion.

Next, the first emulsion was subjected to shearing treatment for 4 minutes by means of an ultrasonic homogenizer to prepare a second emulsion. The second emulsion was evaluated by using DLS8000 (manufactured by Otsuka Electronics Co., Ltd.) and ascertained to have an average particle diameter of 182 nm and a dispersibility index of 1.3.

Next, the second emulsion was set in an evaporator under reduced pressure, thus the chloroform was removed from the second emulsion by evaporation to obtain Fine Particles 2 including the polythiophene. Fine Particles 2 were evaluated by using DLS8000 (manufactured by Otsuka Electronics Co., Ltd.) and ascertained to have an average particle diameter of 82 nm and a dispersibility index of 1.1.

### Example 3

Production of Fine Particles 3

0.2 g of polyethylene was weighed in 6 g of orthodichlorobenzene to prepare a liquid orthodichlorobenzene solution. The solution at this stage was ascertained to have a viscosity of 20 mPa·s or less at 25° C. 0.03 g of sodium dodecyl sulfate (SDS) was dissolved in 30 g of water to prepare an aqueous SDS solution. The liquid orthodichlorobenzene solution and the aqueous SDS solution were mixed to make up a liquid mixture. This liquid mixture was subjected to shearing treatment for 1 hour by means of a stirring homogenizer to make up a first emulsion.

Next, the first emulsion was subjected to shearing treatment for 4 minutes by means of an ultrasonic homogenizer to prepare a second emulsion. The second emulsion was evaluated by using DLS8000 (manufactured by Otsuka Electronics Co., Ltd.) and ascertained to have an average particle diameter of 260 nm and a dispersibility index of 1.4.

Next, to the second emulsion, ethanol was dropwise added little by little at room temperature with stirring, and then this emulsion was subjected to dialysis using in this order an aqueous 50% by mass ethanol solution, an aqueous 10% by mass ethanol solution and water, thus the orthodichlorobenzene was removed from the second emulsion by extraction to prepare Fine Particles 3 including the polyethylene. Fine Particles 3 were evaluated by using DLS8000 (manufactured by Otsuka Electronics Co., Ltd.) and ascertained to have an average particle diameter of 142 nm and a dispersibility index of 1.2.

### Example 4

Production of Fine Particles 4

0.3 g of poly-L-lactic acid was weighed in 6 g of chloroform to prepare a liquid chloroform solution. The solution at this stage was ascertained to have a viscosity of 20 mPa·s or less at 25° C. 0.05 g of sodium dodecyl sulfate (SDS) was dissolved in 24 g of water to prepare an aqueous SDS solution. The liquid chloroform solution and the aqueous SDS solution were mixed to make up a liquid mixture. This liquid mixture was subjected to shearing treatment for 1 hour by means of a stirring homogenizer to make up a first emulsion.

Next, the first emulsion was subjected to shearing treatment for 4 minutes by means of an ultrasonic homogenizer to prepare a second emulsion. The second emulsion was evaluated by using DLS8000 (manufactured by Otsuka Electronics Co., Ltd.) and ascertained to have an average particle diameter of 125 nm and a dispersibility index of 1.2.

Next, the second emulsion was set in an evaporator under reduced pressure, thus the chloroform was removed from the second emulsion by evaporation to obtain Fine Particles 4, containing the poly-L-lactic acid. Fine Particles 4 were evaluated by using DLS8000 (manufactured by Otsuka Electronics Co., Ltd.) to ascertain that the fine particles had an average particle diameter of 59 nm and a dispersibility index of 1.1.

### Example 5

Production of Composite Fine Particles:

First, hydrophobic magnetite was produced in the following way.

FeCl₃ and FeCl₂ were dissolved in water to make up a solution. To this solution, ammonia water was added with vigorous stirring to make up a magnetite suspension. To this suspension, oleic acid was added, followed by stirring at 70° C. for 1 hour and then at 110° C. for 1 hour to make up a slurry. This slurry was washed with a large quantity of water, and then dried under reduced pressure to prepare a powdery hydrophobic magnetite. The resulting hydrophobic magnetite was dispersed in chloroform and evaluation was made by using DLS8000 (manufactured by Otsuka Electronics Co., Ltd.) to ascertain that the hydrophobic magnetite had an average particle diameter of 11 nm and a dispersibility index of 1.3.

Next, 0.3 g of polystyrene and 0.3 g of the hydrophobic magnetite were weighed in 6 g of chloroform to prepare a liquid chloroform mixture. This liquid mixture was ascertained to have a viscosity of 20 mPa·s or less at 25° C. 0.05 g of sodium dodecyl sulfate (SDS) was dissolved in 24 g of water to prepare an aqueous SDS solution. The liquid chloroform mixture and the aqueous SDS solution were mixed to make up a liquid mixture. This liquid mixture was subjected to shearing treatment for 1 hour by means of a stirring homogenizer to make up a first emulsion.

Next, the first emulsion was subjected to shearing treatment for 4 minutes by means of an ultrasonic homogenizer to prepare a second emulsion. The second emulsion was evaluated by using DLS8000 (manufactured by Otsuka Electronics Co., Ltd.) and ascertained to have an average particle diameter of 208 nm and a dispersibility index of 1.2.

Next, the second emulsion was set in an evaporator under reduced pressure, thus the chloroform was removed from the second emulsion by evaporation to prepare composite fine particles including the polystyrene and the hydrophobic magnetite. The composite fine particles were evaluated by using DLS8000 (manufactured by Otsuka Electronics Co., Ltd.) and ascertained to have an average particle diameter of 152 nm and a dispersibility index of 1.1.

### Comparative Examples

Predetermined quantities of polystyrene was weighed in 6 g of chloroform to prepare five types of liquid chloroform solutions having viscosities of (1) 8 mPa·s, (2) 12 mPa·s, (3) 17 mPa·s, (4) 20 mPa·s and (5) 22 mPa·s at 25° C. 0.05 g of sodium dodecyl sulfate (SDS) was dissolved in 24 g of water to prepare an aqueous SDS solution. Each of the liquid chloroform solutions (1), (2), (3), (4) and (5) was mixed with the aqueous SDS solution to make up a liquid mixture. The liquid mixture was subjected to shearing treatment for 1 hour by means of a stirring homogenizer to make up a first emulsion.

Next, the first emulsion was subjected to shearing treatment for 4 minutes by means of an ultrasonic homogenizer to prepare a second emulsion.

The second emulsion was evaluated by using DLS8000 (manufactured by Otsuka Electronics Co., Ltd.) and found to have such a dispersibility index as shown below.

That is, in the second emulsion prepared from the chloroform solution (1), its dispersibility index was 1.1; in the second emulsion prepared from the chloroform solution (2), 1.2; in the second emulsion prepared from the chloroform solution (3), 1.4; and in the second emulsion prepared from the chloroform solution (4), 1.5.

The second emulsion prepared from the chloroform solution (5) showed particle size distribution with a plurality of peaks, and hence was ascertained to be unable to achieve the objective of the present invention.

Next, each of the second emulsions was set in an evaporator under reduced pressure, thus the chloroform was removed from the second emulsion by evaporation to prepare composite fine particles containing the polystyrene. The composite fine particles were evaluated by using DLS8000 (manufactured by Otsuka Electronics Co., Ltd.) and ascertained to have a dispersibility index as shown below.

That is, in the fine particles prepared from the chloroform solution (1), the dispersibility index was 1.1; in the fine particles prepared from the chloroform solution (2), 1.1; in the fine particles prepared from the chloroform solution (3), 1.3; and in the fine particles prepared from the chloroform solution (4), 1.5. The fine particles prepared from the chloroform solution (5) showed particle size distribution with a plurality of peaks, and hence were ascertained to be unable to achieve the objective of the present invention.

According to the present invention, the fine particles whose particle diameter and particle size distribution have been controlled can readily be produced using a polymer in conformity with intended use, and with the aim of endowing the fine particles with further functions, the composite fine particles can efficiently be produced. Thus, the present invention is utilizable in the fields of electronic materials, optical materials and medical materials.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-236723, filed Aug. 31, 2006, which is hereby incorporated by reference herein in its entirety.

1. A process for producing fine particles, comprising the steps of:
(1) preparing a solution having a viscosity of 20 mPa·s or less at 25° C. by using a polymer and a first solvent;
(2) mixing the solution with a second solvent to prepare an emulsion; and
(3) removing the first solvent from the emulsion to obtain fine particles containing the polymer.

2. The process for producing fine particles according to claim 1, wherein the polymer is soluble in the first solvent and slightly soluble in the second solvent.

3. The process for producing fine particles according to claim 1, wherein the first solvent is immiscible with the second solvent.

4. The process for producing fine particles according to claim 1, wherein the emulsion has one-peak particle size distribution.

5. The process for producing fine particles according to claim 1, wherein the emulsion has an average particle diameter of 20 nm or more and 1,000 nm or less.

6. The process for producing fine particles according to claim 1, wherein a dispersing agent is contained in at least one of the first solvent and the second solvent.

7. The process for producing fine particles according to claim 1, wherein the step of preparing the emulsion comprises a step of mixing the solution with the second solvent to prepare a first emulsion and a step of subjecting the first emulsion to shearing treatment to prepare a second emulsion.

8. The process for producing fine particles according to claim 1, wherein a functional material is used in addition to the polymer and the first solvent to prepare the solution to obtain composite fine particles containing the polymer and the functional material.
